(19) United States
(12) Patent Application Publication
(10) Pub. No.: US 2004/0225518 A1
(43) Pub. Date: Nov. 11, 2004

(54) Bounty system for generating charitable contributions

(76) Inventor: David Bain, Arlington, VA (US)

Correspondence Address: Merek, Blackmon & Voorhees, LLC, 673 S. Washington St., Alexandria, VA, 22314, US

(21) Appl. No.: 10/730,937

(22) Filed: Dec. 10, 2003

Related U.S. Application Data
(60) Provisional application No. 60/432,026, filed on Dec. 10, 2002.

(51) Int. Cl. G06F 17/60

(52) U.S. Cl. 705/1

(57) ABSTRACT

A system and method for generating large philanthropic funds through the use of a high entertainment value fund raising venue. Until now, the creation of large bounties to address societal problems has been the exclusive right of large philanthropists. If someone created a six million dollar reward for the eradication of a disease or solution of a problem, you might expect them to have a last name like Gates, Turner, Getty, Rockefeller, or Nobel. Small philanthropists, even though they may collectively account for the vast majority of all donations, have until now had little creative involvement and no real voice in how their donations were spent. The Bounty Fund offers large and small philanthropists alike the opportunity to design bounties with the potential to surpass those traditional bounties in terms of quality of creative design, magnitude, and mindshare.

This application claims the benefit of provisional application 60/432,026 filed Dec. 10, 2002, which is incorporated herein by reference.

### BACKGROUND OF THE INVENTION

A. Field of the Invention

The present invention relates to a method and system for raising bounties for an organization through competitive contests and high entertainment-value events. For the purposes of this document, Bounty is defined as any reward that is given or released upon the occurrence of certain event(s) or satisfaction of certain condition(s).

B. Description of the Prior Art

Despite the general affluence of American society today, there will always remain a need to raise money to help those less fortunate or to generate revenue to support causes and goals that are not economically self-sustaining. Current methods of raising money include telephone calls to individuals and residence to solicit money, telethons, pledge drives, religious tithing, mass mailing, entertainment ticket sales (such as LIVE AID, FARM AID, etc.) and many other ways to try to reach out to large pools of individuals in the hopes that some will donate to the cause.

The Bounty Fund is a provider of methodologies and Internet infrastructure for aggregating donations for bounties or rewards. Philanthropists may, from The Bounty Fund or similar websites, launch a bounty or bounty-related contest. The Bounty Fund is an aggregator of donations for bounties. Moreover, The Bounty Fund harnesses the creative genius of large and small philanthropists, empowering them to define their contests in ways that may educate, build awareness about a problem, and command susbstantial media attention.

For example, if there is a medical condition for which there is no cure, such as schizophrenia, Alzheimer's, or cancer, your money alone will do little to motivate scientists or pharmaceutical companies to address your problem. Your money alone will, however, allow you to open a bounty for the eradication of such a disease. The bounty amount may grow (according to the interest rate at which it is responsibly invested by third party money managers) and be pooled with the donations of other philanthropists until the bounty is a very powerful incentive indeed. Additionally, bounties may be placed for achieving at least a precisely stated threshold of progress against a problem, especially where complete eradication of the problem is unlikely.

After a bounty proposal is reviewed (and amended if needed) and accepted for posting to the site, the dollar amount connected to that bounty becomes visible in real time via the site. A press release is generated about the new bounty and XML links to sites of the organizations related to fight against the problem are offered. The dollar amount increases in real time like a digital clock (on our web-based “bounty counter”). The prize money is claimed and paid with appropriate ceremony after the reviewing committee confirms the veracity of the claimant's evidence of meeting the conditions of the bounty.

When bounties center around specific diseases or medical conditions, the question eventually arises “Should I donate to the research effort or to the bounty for the cure?” First of all, a bounty contest may be organized in a way that makes the research effort be the pre-determined beneficiary of the fund raising. In the case of a “classic bounty” where the party meeting the challenge of the bounty (curing the disease) receives the reward, several benefits unique to bounties may be noted:

Bounties cause all parties concerned to envision and focus on the successful result; increasing bounties are suspenseful like a lottery and accordingly command media attention and mindshare in ways that other funding mechanisms cannot. Accordingly, bounties possess unique power to create issue awareness and educate. Bounties sharpen the competition between researchers and research organizations; Bounties may be directed at problems such as “orphan illnesses” (illnesses which may not be widespread or otherwise do not represent profitable R&D targets for pharmaceutical companies or direct research funding); Bounties may leverage not only the financial resources, but also the valuable creativity of the benefactors; 100% of donations go to the actual cause for which funds are raised (with other fundraising, administrative expenses commonly consume 40% or more); The most popular bounties may be things you may not expect. A “classic bounty” on curing Parkinson's may have 10 donors at $100,000 each, while a bounty to release pooled money to a Parkinson's research fund when [X celebrity personality does X silly activity] may receive 1,000,000 donations of $10. Accordingly, funds may be generated for addressing any number of societal problems by bounties for Anna Kournikova riding a horse in Lady Godiva fashion from the Washington Monument to the Capitol. Bounties may take on this “dare” nature as long as it is legal, non-liability-incurring, and for a good cause. All bounties are carefully and candidly reviewed for acceptability. Schools, churches, companies, and local organizations may use the Bounty Fund to organize fundraisers around bounty-related events.

None of the prior methods fully utilizes the entertainment quotient of today's televised “real life” shows and the natural competitive nature of individuals. The current invention offers a method of raising money by providing a high entertainment value venue for raising charitable funds in conjunction with (or in place of) an interactive internet form to encourage viewers to “pay” for the entertainment through charitable gifts and pledges.

In the preferred embodiment, an Internet website is provided for allowing individuals or organizations to create a bounty that is payable to a charity or cause upon the satisfaction of a certain event or events. The event (“condition”) that triggers the payment of the bounty may be the accumulation of a number of pledges from individuals to release a matching gift or other endowment. The triggering event can also be a non-monetary event such as a celebrity or other individual or entity (“actor”) performing a certain pre-designated entertainment-related activity, such as a screen-star agreeing to a blind date with the winner of a competition. And likewise the triggering event (“condition”) can simultaneously act as an incentive for the general public to donate to the cause to win the incentive.

None of the above inventions and patents, taken either singly or in combination, is seen to describe the instant invention as claimed.

### SUMMARY OF THE INVENTION

The present invention is accomplished by providing and supporting a website for holding “bounty” type charitable fund raising events.

Accordingly, it is a principal object of the invention to provide a website where entities (“benefactor” or “claimant”) interested in raising funds can register the proposed bounty on a central website.

It is another object of the invention to provide a central website (“bounty site”) for facilitating fundraising, by providing registrants with a system for choosing triggering events (“conditions”), fund goals, conditions and endowment pledges benefactor pledges as well as a central location for advertising, managing, and hosting the fund raising event.

It is a further object of the invention to provide a central website having an internal management for controlling the quality and content of the website and to manage the funds being raised to ensure the reputation and character of the site to maximize the value of the fund and the site.

Still another object of the invention is to provide a central location for attracting potential contributors to the site to select which charity or cause to contribute, and to encourage further contributions by providing a competition-oriented high entertainment value site.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a diagrammatic view of the bounty site according to a preferred embodiment of the invention.

Similar reference characters denote corresponding features consistently throughout the attached drawings.

### DETAILED DESCRIPTION OF THE PREFERRED EMBODIMENT(s)

The present invention is to a bounty site for raising capital for charitable and preferred organizations and causes.

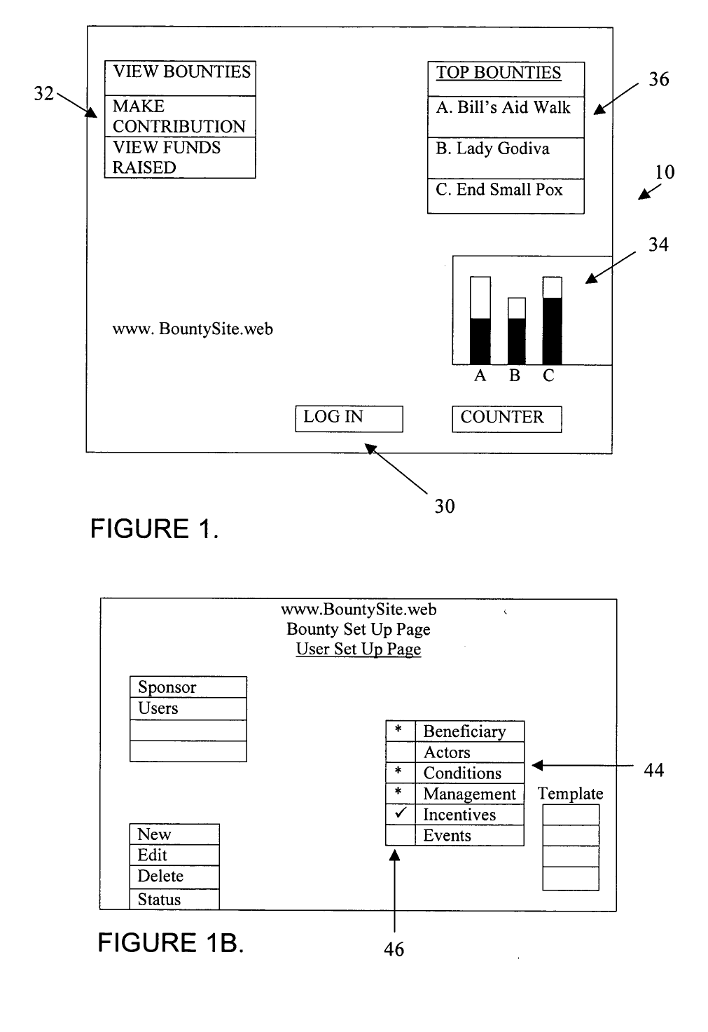

The invention is best described through by example. FIG. 1 shows a home page 10 of a rudimentary website for carrying out the invention. The webpage has a domain name www.BOUNTYSITE.WEB, where “.web” represents a top level domain on the world wide web, internet, or other network, but could as easily represent a lower level domain.

A user, through the use of a browser, personal digital assistant, cellular telephone, or other software or device, entering the site will be presented with a number of presentations and selections either in textual or graphical form. Preferably the site has a display 20 for showing at least one current bounty in progress, and lists 32 selectable to view bounties, contribute to bounties, view funds raised, or log in 30 to set up or perform maintenance of bounties. The page may also contain additional graphics 34 showing the relative performance of select bounties.

However, the web site is merely a preferred vehicle for displaying and advertising the bounties undertaken and an inexpensive and convenient means of interacting with the general public. Television, telephones, kiosks and other means could be used to achieve the goal using the methods described below.

In order to raise funds, a sponsor registers with the Bounty manager. The manager provides a number of options for setting up a bounty fund. These options include:

A. Beneficiary (method of determining beneficiaries)—the beneficiary is the organization, individual or cause that receives the bounty once released. Several different beneficiaries may result from a single Bounty.

B. Actors party or parties meeting the conditions or attempting to meet the conditions of the Bounty.

C. Conditions for disbursement of Bounty—Bounty assets (funds, goods, services, other incentives) may be disbursed in part or full according to Conditions for the disbursement.

D. Bounty fund management options—Bounty funds management options including choice of auditor, funds manager, investment methods, vehicles and risk level of investment may be determined by Sponsor or determined through the process of the Conditions of the Bounty.

E. Benefactors—Sources of assets (funds, goods, services, other incentives) for the Bounty may be determined by Sponsor or determined through the process of the Conditions of the Bounty.

F. Incentives—in addition to the beneficiary's primary incentive of the Bounty Assets, incentives may be defined for Beneficiaries, Actors, Benefactors, and Sponsors. For example, top benefactors may be invited to be present at a special awards ceremony for the granting of the bounty.

G. Events—Typical event formats may include television series, press conference-style or “night at the Oscars”-style awards ceremonies.

In the preferred embodiment, the Bounty manager provides a web site 10 for registering the desired Bounty. A sponsor that desires to set up the bounty enters the URL for the Bounty Manager site, such as WWW.BOUNTYSITE.WEB, for the purposes of this illustration is a valid domain name or other valid internet or other network address. The sponsor then selects “Log In” 30 to register information about the bounty and about those users authorized to edit information about the bounty.

Registration of the sponsor and sub-users authorized to edit and change information on the bounty is achieved through any of well-known methods of collecting information and passwords and security levels on the sponsor, and will not be discussed herein. The collected information may include, name, user id, password, additional passwords, security level, address, phone number(s), and additional identifying information.

One the sponsor is registered and authorized to set up a bounty, the sponsor identifies the set up of the bounty through the players (“actors”), events, and conditions of the bounty. In the preferred method, a listing 44 of the different variables is provided as an entry point for entering the desired information. The listing 44 may have additional graphics 46 denoting required information, optional information, or the status (“entered, not entered”) for each field.

The bounty preferably is created by naming the Bounty for identification, and by the sponsor entering the individual fields and their interrelation:

A. Beneficiary (method of determining beneficiaries)—the beneficiary or beneficiaries may be predetermined, may be determined through the process of the Bounty, may be concealed, revealed, or any combination of the above. Random, bid-based, and/or algorithmic determination and/or threshold values for time, assets, number of participants, or other metrics may be used in determining beneficiary or beneficiaries or method of beneficiary selection. The Beneficiary may also be an “actor,” such as the first organization to find a cure for a previously uncured disease.

B. Actors party or parties meeting the conditions or attempting to meet the conditions of the Bounty—“actors” in the Bounty or those striving to meet the conditions of the Bounty may be predetermined, may be determined through the process of the Bounty, may be concealed, revealed, or any combination of the above. Random, bid-based, and/or algorithmic determination and/or determined threshold values for time, assets, number of participants, or other metrics may be used in determining actor(s) or method of actor selection.

C. Conditions for disbursement of Bounty—Bounty assets (funds, goods, services, other incentives) may be disbursed in part or full according to Conditions for the disbursement. Random, bid-based, and/or algorithmic determination and/or determined threshold values for time, assets, number of participants, or other metrics may be used in determining Conditions for disbursement(s) or method for Conditions for disbursement selection.

D. Bounty fund management options—Bounty funds management options including choice of auditor, funds manager, investment methods, vehicles and risk level of investment may be determined by Sponsor or determined through the process of the Conditions of the Bounty. Sponsor may allow or disallow pre-disbursement of Bounty assets for parties wishing to use the bounty assets to meet the Conditions of the Bounty.

E. Benefactors—Sources of assets (funds, goods, services, other incentives) for the Bounty may be determined by Sponsor or determined through the process of the Conditions of the Bounty. Random, bid-based and/or algorithmic determination and/or determined threshold values for time, assets, number of participants, or other metrics may be used in determining benefactor (s) or method of benefactor selection. If merchants are allowed offer commissions on their goods and services to be donated to the Bounty, a search engine of such merchants based on their location, category of goods and services, and commission level may be included. Benefactors may be given options to make the amount of their donation be determined through the Conditions of the bounty and corresponding actions of other bounty benefactors (such as through the sponsorship of a matching grant), through the actions of the actors, beneficiaries or other parties involved in the bounty.

F. Incentives—in addition to the beneficiary's primary incentive of the Bounty Assets, incentives may be defined for Beneficiaries, Actors, Benefactors, and Sponsors. Incentives may include funds, goods, services, promotional offers, promotional rights and considerations, advertising/public relations opportunities, and incentives. For example, top benefactors may be invited to be present at a special awards ceremony for the granting of the bounty.

G. Events—specific template and customizable formats, may be selected for ceremonies or events related to the bounty. Typical event formats may include television series, press conference-style or “night at the Oscars”-style awards ceremonies.

As an alternative, templates can be provided with the interrelation of all of the variables to simplify entry of the data and to benefit from standardization of the bounties. For example, if entering a simple bounty wherein a benefactor will release a certain amount of funds once a certain “matching” amount has been donated by the general public, then the Benefactor (as sponsor) would enter the following:

A. Beneficiary: Mother Superior Charity Fund Drive

B. Actors: General Public

C. Conditions: We will donate $100,000 if the fund raises at least a matching $100,000 through general donations

D. Bounty Fund Management Options: Bounty Fund Managed

E. Benefactor: John Smith Foundation

F. Incentives: Donations over $100 get John Smith Foundation Pen

G. Events: None

Other popular templates include:

“Classic Bounty” Non-predetermined beneficiary/non-predetermined party meeting the conditions of the Bounty/non-predetermined time of conclusion. E.g. Dr. Jane Doe meets the conditions for the disbursement of the Bounty (curing Parkinson's disease) and is awarded the full Bounty.

“High visibility fundraiser” Pre-determined beneficiary/pre-determined party meeting the conditions of the Bounty/non-predetermined or pre-determined time of conclusion. E.g. a non-profit organization names itself as a pre-determined beneficiary of a Bounty.

Once the site is registered, an internal quality management committee (or individual) in the Bounty management may review the bounty and compare the goals or conditions, incentives, etc. to ensure that they comply with the general principles and rules of the Bounty management. Changes can be required or suggested or negotiated with the Sponsor before the Bounty is published. The Bounty can also be published without review. The management may also be used to determine compliance with all of the conditions, etc. before the funds are released. Management can also insist that certain waivers, etc. are signed to release participants or the Bounty Management from certain liabilities.

Once the Bounty is published, users visiting the site can view the Bounty by selecting “View Bounty” 32 or by other graphic or textual lists or representation of the Bounty, such as by “Top 10” lists of the bounties or, for instance, by graphical comparison charts. This is especially important if bounties are run in competition with each other. As incentives within a particular bounty or as a separate bounties, an condition for the release of a particular award could be the first of named (or unnamed) bounties to reach a certain goal, an additional award is given to that Bounty's beneficiary. The goal can be a general goal applicable to all the competing bounties, or may be varied between the competing bounties to account for size, location, or for other reasons.

This inter-bounty competition can be used as an incentive for users to donate earlier to their favorite charity. This could be an especially useful incentive for diving donation s for instance between school clubs or between rival schools. It is well known that competition is a particularly useful incentive to drive potential donators to donate higher amounts to reach concrete, defined goals or to drive the excitement (“entertainment value”) by watching a particular goal being reached.

Of course, where the reward or incentive has been listed in dollar amounts, other forms of reward could be used, such as, but not limited to, frequent flier miles, coupons, credits, rebates, or other similar devices.

Likewise, the additional built-in entertainment features of the bounty fund that are designed to increase donations by providing high entertainment value to the fund included, but are not limited to:

A. Actors and Conditions—One of the central purposes of the bounty fund is to provide entertaining conditions that the actors must complete, such as a governor running a 10k or a celebrity appearing at a school event, or a supermodel to complete a farcical activity. Of course the event could be an unnamed general public donor completing some challenging event. Likewise celebrities needing additional exposure, agents, or other “famous” individuals can use contact a bounty directly or may use a matching service provided by the bounty fund site or independently operating to match a bounty to a celebrity for a particular theme, cause, or level of exposure.

B. Incentives—By providing additional awards to either donors or to the actors who complete conditions, a competition can be set up between the donors to receive the awards, such as top donor receives a date with a supermodel, who may in turn be an “Actor” of the bounty. Or the top 100 donors may go to a celebrity filled event.

C. Graphical Feedback—The use of a website or a television, such as in the spirit of a telethon, can be used to provide graphical feedback to the general public or specifically to the donors. By watching the progress of the bounty towards its goal, or the broadcast of actors completing conditions, or the broadcast of incentives being awarded to donors or actors, the general public and potential donors become a part of the bounty. By providing this entertainment tied to the potential donors through the feedback, the potential donors are more likely to contribute more to try to see the Bounty through to completion.

D. Bounty Counter—Related to the Graphical Feedback, a Bounty Counter can be provided to return a “real time” accounting of individual funds, groups of funds, or of all the funds total. The Bounty Counter may provide in addition to the total “donations” an accounting of accumulating interest and principal, comparison to other “competing funds” or the like.

E. Competition—As an integral part to the actors, conditions, incentives, and graphical feedback, one of the driving underlying themes is the ability to provide incentives through competition. The competition can be between the actors, donors, or general public, and the method of keeping people involved in the competition and their ability to be spurred on to continue competing is through the graphical feedback.

F. Single or Multiple Bounties as the Entertainment basis—The bounty itself may be used as the focus of the entertainment. A television show may be developed around the bounty itself, in either an 1) single bounty format or 2) a multiple bounty format:

1. In a single bounty television format, a show could be broadcast “live” (e.g., real time live or recorded in front of a live audience) in an interactive format or as a “documentary” showing canned footage. In the documentary format, a bounty in one of the embodiments described above could be posted on the internet while clips of videos showing films about the cause for which money is being raised can be shown, or alternatively, video could be shown strictly of entertainment value (e.g., classic black and white films) with “plugs” for the bounty shown intermittently. In an interactive format, the television show could act as a classic “telethon” with contributions taken at least in part by an internet bounty site instead of or in addition to contributions pledged by telephone. A more dynamic interactive format would involve actor actions contingent on viewer actions. This could take the form of a simple actor promotion, such as “I will jump in the pool of ice water, if we raise at least $1000 dollars in the next 10 minutes.” Or more complex, such as an interactive vote-contingent play, where the audience votes with dollars for the how a play should proceed, such as “pledge to option A if you want the villan to kill his wife, or pledge to option B if you want the villan to take his wife back” with the option raising the most money causing the actors to proceed according to the more favored options throughout the play.

2. In a multiple bounty contest, for example, a television show could be used to have participants develop or promote competing bounties (“meta contest”) with the winner judged on an objective metric such as most money raised, or by other metrics such as most awareness developed, opinions or behaviors changed, problems solved, or conditions improved. In a meta contest, celebrities or other participants would develop bounties using their own services or actions as incentives for people to donate to the bounty, or can use other incentives. The television show can either track the progress of the bounties, or is preferably used to carry out incentives and other entertainment vehicles or contests to draw viewers and contributors. The television show could also be used to show participants compete in contest which result in funds being added to their bounty as well, such as answering a trivia question correctly resulting in $500 being donated by the promoters to the contestant's bounty.b As in the single bounty televised events, the show could be documentary in style or live. Additionally, the shows could be serial with a bounty continuing from one show to the next or could take place in a single show. Top contestants could also be chosen to continue to another show while less successful contestants are dropped.

Additionally, it is possible to use outside sponsors, merchants, advertisers, or non-specified donations to provide additional capital to the funds or to support operation and management of the site. Merchants can pay directly to advertise goods on the sites, or pay “referral fees” or percentage of sales resulting from the advertising on the sites. Sales can also be made through the site of merchant's goods or other goods to increase the funds allocated to the bounties or to the operation of the site. It is also possible that Merchants can advertise independently (e.g. “for every can of soup sold or every dollar donated to alpha bounty site, we will donate ten cents.”) This matching of Merchants to funds may be achieved by an automated or manual matching service provided by the site or operated independently.

It is to be understood that the present invention is not limited to the sole embodiment described above, but encompasses any and all embodiments within the scope of the following claims.

I claim:

1. A method of raising money comprising the steps of:
A. creating an internet site, and
B. creating a bounty by selecting a beneficiary, actor, condition, benefactor, incentive and events:

2. A method of raising money comprising the steps of:
A. creating an internet site, and
B. creating a bounty by selecting a beneficiary, actor, condition, benefactor, incentive and events,
C. broadcasting the bounty on a television show.
